(19) United States
(12) Patent Application Publication
(10) Pub. No.: US 2002/0114058 A1
(43) Pub. Date: Aug. 22, 2002

(54) Light-transmissive substrate for an optical MEMS device

(76) Inventors: Dana Richard DeReus, Colorado Springs, CO (US); Shawn J. Cunningham, Colorado Springs, CO (US); Arthur S. Morris III, Raleigh, NC (US)

Correspondence Address: JENKINS & WILSON, PA, 3100 TOWER BLVD, SUITE 1400, DURHAM, NC, 27707, US

(21) Appl. No.: 10/025,188

(22) Filed: Dec. 19, 2001

Related U.S. Application Data
(60) Provisional application No. 60/256,688, filed on Dec. 19, 2000.
(60) Provisional application No. 60/256,604, filed on Dec. 19, 2000.
(60) Provisional application No. 60/256,607, filed on Dec. 19, 2000.
(60) Provisional application No. 60/256,610, filed on Dec. 19, 2000.
(60) Provisional application No. 60/256,611, filed on Dec. 19, 2000.
(60) Provisional application No. 60/256,674, filed on Dec. 20, 2000.
(60) Provisional application No. 60/256,683, filed on Dec. 19, 2000.
(60) Provisional application No. 60/256,689, filed on Dec. 19, 2000.
(60) Provisional application No. 60/260,558, filed on Jan. 9, 2001.

(51) Int. Cl. G02F 1/29; G02B 26/08; G02B 26/00

(52) U.S. Cl. 359/298; 359/291; 359/292

(57) ABSTRACT

Light-Transmissive Substrate for an Optical MEMS Device. According to one embodiment of the present invention, an optical device is provided. The optical device includes a substrate having an aperture for providing a pathway for light transmission and a device attached to a surface of the substrate for interacting with light transmitted along the pathway. According to another embodiment of the present invention, an optical device is provided which includes a substrate manufactured of a light-transmissive material having surfaces coated with an anti-reflective material for providing a pathway for light transmission and a device attached to a surface of the substrate for interacting with light transmitted along the pathway.

### CROSS-REFERENCE TO RELATED APPLICATION

This nonprovisional application claims the benefit of U.S. Provisional Application No. 60/256,688, filed Dec. 19, 2000, U.S. Provisional Application No. 60/256,604, filed Dec. 19, 2000, U.S. Provisional Application No. 60/256,607, filed Dec. 19, 2000, U.S. Provisional Application No. 60/256,610, filed Dec. 19, 2000, U.S. Provisional Application No. 60/256,611, filed Dec. 19, 2000, U.S. Provisional Application No. 60/256,674, filed Dec. 19, 2000, U.S. Provisional Application No. 60/256,683, filed Dec. 19, 2000, U.S. Provisional Application No. 60/256,689, filed Dec. 19, 2000, and U.S. Provisional Application No. 60/260,558, filed Jan. 9, 2001, the disclosures of which are incorporated by reference herein in their entirety.

### TECHNICAL FIELD

The present invention relates to micro-electro-mechanical systems (MEMS) devices. More particularly, the present invention relates to MEMS devices for interacting with light transmitted along a pathway.

### BACKGROUND ART

In communication networks, optical transmission systems are often used for the transmission of data signals between network terminals such as telephones or computers. Optical transmission systems transmit data signals via data-encoded light through fiber optics. Many functions in optical switching systems require the movement of an actuating device in order to interact with the light output from “incoming” fiber optics. Among the functions requiring light interaction are redirecting light from one fiber optic to another, shuttering light, filtering light, and converting light output to electrical form.

In order to perform optical switching system functions, micro-electromechanical systems (MEMS) devices are typically employed to interact with the light transmitted along a light pathway. MEMS is a technology that exploits lithographic mass fabrication techniques of the kind that are typically used by the semiconductor industry in the manufacture of silicon integrated circuits. Generally, the technology involves shaping a multilayer structure by sequentially depositing and shaping layers of a multilayer wafer that typically includes a plurality of polysilicon layers that are separated by layers of silicon oxide and silicon nitride. Typically, individual layers are shaped by a process known as etching. Etching is generally controlled by masks that are patterned by photolithographic techniques. MEMS technology can involve the etching of intermediate sacrificial layers of the wafer to release overlying layers for use as thin elements that can be easily deformed or moved to function as an actuator. After the process of fabrication, the resulting MEMS device is left attached to a base layer substrate.

In order to provide optical communication with other devices, a pathway must be provided to an optical MEMS device for the unimpeded transmission of light. Typically, light intended for interaction with an optical MEMS device is transmitted along a light pathway parallel to the substrate surface on which the optical MEMS device is fabricated. This configuration of the substrate and light pathway is problematic when trying to maximize the number of optical MEMS devices arranged in an array on a substrate surface.

Therefore, it is desirable to provide for a way to maximize the number of MEMS devices fabricated on a given substrate surface. Furthermore, it is desirable to provide a low cost method for providing a light pathway to an optical MEMS device.

### DISCLOSURE OF THE INVENTION

According to one aspect of the present invention, an optical device is provided that comprises a substrate having an aperture for providing a pathway for light transmission. The optical device includes a device attached to a surface of the substrate for interacting with light transmitted along the pathway.

According to a second aspect of the present invention, an optical device is provided that comprises a light-transmissive material having a surface portion coated with an anti-reflective material for providing a pathway for light transmission. Furthermore, the optical device includes a device attached to a surface of the substrate for interacting with light transmitted along the pathway.

Accordingly, it is an object of the present invention to provide an optical device for providing a pathway for light through a substrate to an optical MEMS device.

Some of the objects of the invention having been stated hereinabove and which are achieved in whole or in part by the present invention, other objects will become evident as the description proceeds when taken in connection with the accompanying drawings as best described hereinbelow.

### BRIEF DESCRIPTION OF THE DRAWINGS

Exemplary embodiments of the invention will now be explained with reference to the accompanying drawings, of which:

FIG. 1 illustrates a cross-sectional view of a substrate having an aperture for providing a pathway for the transmission of light to an optical MEMS device in accordance with an embodiment of the present invention;

FIG. 2 illustrates a cross-sectional view of a light-transmissive substrate having surfaces coated with an anti-reflective material for providing a light pathway to an optical MEMS device in accordance with a second embodiment of the present invention;

FIG. 3 illustrates a cross-sectional view of a substrate having a MEMS device and cover attached thereto for providing a light pathway for the transmission of light to the optical MEMS device in accordance with an embodiment of the present invention;

FIG. 4 illustrates a cross-sectional view of a substrate having a MEMS device and cover attached thereto for providing a light pathway to the optical MEMS device in accordance with another embodiment of the present invention;

FIG. 5 illustrates a cross-sectional view of a substrate having a MEMS device and cover attached thereto for providing a light pathway to the optical MEMS device in accordance with another embodiment of the present invention;

FIG. 6 illustrates a cross-sectional view of a substrate having a MEMS device and cover attached thereto for providing a light pathway to the optical MEMS device in accordance with another embodiment of the present invention;

FIG. 7 illustrates a diagram of exemplary motion of a component along a substrate surface in relation to a light pathway extending in a direction perpendicular to a substrate surface;

FIG. 8 illustrates a schematic diagram of an electrostatic comb-drive type MEMS device for moving a component in a linear direction parallel to a substrate surface;

FIG. 9 illustrates a schematic diagram of a thermal, bent-beam actuator type MEMS device for moving a component in a linear direction parallel to a substrate surface;

FIG. 10 illustrates a schematic diagram of a linear actuator type MEMS device for moving a component in a linear direction parallel to a substrate surface;

FIG. 11 illustrates another diagram of exemplary motion of a component along a substrate surface in relation to a light pathway extending in a direction perpendicular to a substrate surface;

FIG. 12 illustrates a schematic diagram of a MEMS device having an electrostatic micromotor for moving a component in a curvilinear direction parallel to a substrate surface;

FIG. 13 illustrates a schematic diagram of a MEMS device having an electrostatic micromotor for moving a component in a parallel to a substrate surface;

FIG. 14 illustrates a schematic diagram of an electrostatic, curved electrode actuator for moving a component in a curvilinear direction parallel to a substrate surface;

FIG. 15 illustrates a schematic diagram of a thermal actuator moving a component in a curved line in a plane parallel to the plane of a substrate surface;

FIG. 16 illustrates a schematic diagram of an MEMS device actuator for moving a component in a curved line in a plane parallel to the plane of a substrate surface;

FIG. 17 illustrates another diagram of exemplary motion of a component along a substrate surface in relation to a light pathway extending in a direction perpendicular to a substrate surface;

FIGS. 18A and 18B illustrate diagrams of a top and side view, respectively, of the exemplary curling motion of a component from a position intercepting a light pathway to a position outside the light pathway;

FIGS. 19A and 19B illustrate diagrams of a top and end view, respectively, of a set of MEMS devices, each having a torsional mirror each associated with an absorbing and reflecting plate for interacting with transmitted light; and

FIGS. 20A and 20B illustrate diagrams of an end and a cross-sectional top view, respectively, of a set of MEMS devices having a shutter for interacting with transmitted light.

### DETAILED DESCRIPTION OF THE INVENTION

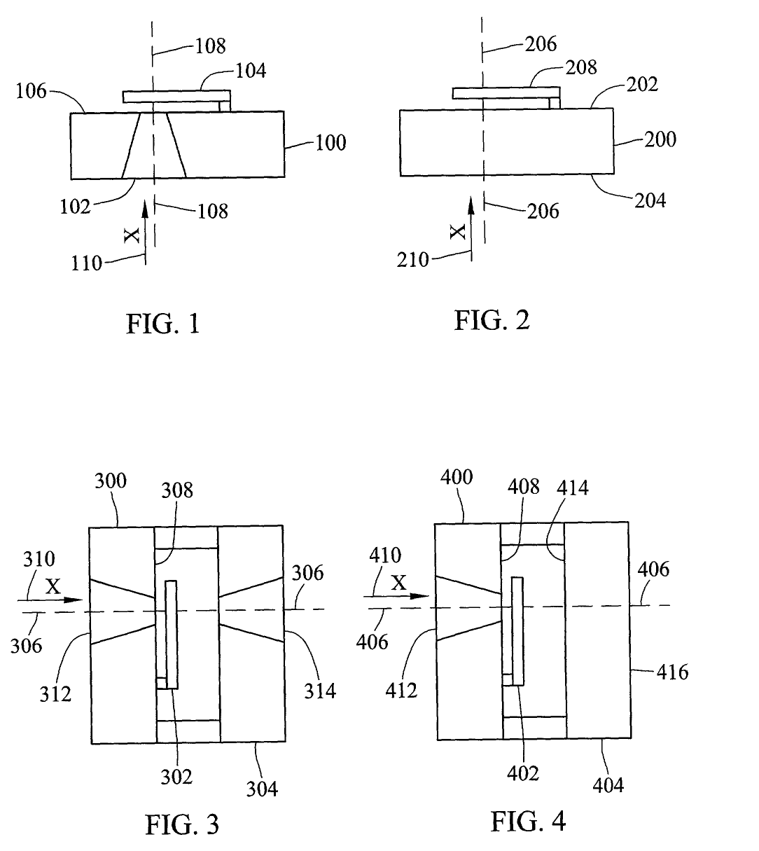

In accordance with the present invention, a substrate having a pathway for the transmission of light to an optical MEMS device attached thereto is provided. Referring to FIG. 1, a cross-sectional side view of a substrate 100 having an aperture 102 for providing a pathway for the transmission of light to an optical MEMS device 104 is illustrated in accordance with an embodiment of the present invention. MEMS device 104 is attached to a surface 106 of substrate 100. In this embodiment, light is provided a pathway through aperture 102 for allowing the unimpeded transmission of light along pathway 108 (indicated by a broken line) through substrate 100.

Substrate 100 can be made of any material suitable for attaching MEMS device 104 thereto. In this embodiment, substrate 100 is manufactured of silicon. Alternatively, substrate 100 can be manufactured of glass, gallium arsenide (GaAs), quartz, sapphire, silicon-on-insulator, or any other suitable material compatible with MEMS device 104.

Pathway 108 extends through aperture 102 toward MEMS device 104 for interaction with MEMS device 104. Light can be transmitted in a direction indicated by direction arrow x 110 along pathway 108 and through substrate 100 or along pathway 108 in a direction opposite direction arrow x 110. Examples of MEMS devices for interacting with light are described hereinafter.

Aperture 102 is provided through substrate 100 for allowing the unimpeded transmission of light along pathway 108. Aperture 102 can be manufactured in substrate 100 by anisotropic etching in suitable etchants, such as potassium hydroxide (KOH), ethylenediamine pyrochatechol (EDP), and tetramethyl ammonium hydroxide (TMAH) solutions. Anisotropic etchants such as KOH, TMAH, and EDP are crystal plane dependent etches which selectively attack different crystallographic orientations of silicon at different rates, and thus can be used to define accurate sidewalls in aperture 102. In this embodiment, substrate 100 is a silicon wafer with an etch mask that defines the wide opening of aperture 102. As an etchant removes silicon material from the aperture it will etch through substrate 100 at a higher rate and laterally in substrate 100 at a slower rate. Substrate surface 106 is defined by the crystal plane that has a high etch rate. The sidewalls of aperture 102 are defined by the silicon crystal plane, which etch at a lower rate. The differing etch rates along crystal planes produce the geometric features of aperture 102 shown in substrate 100. Alternatively, aperture 102 can be formed by anisotropic deep reactive ion etching (DRIE) that forms a hole with vertical sidewalls (not shown) or by any other suitable microfabrication process that produces apertures.

Alternatively, a light pathway can be provided through a substrate by providing a light-transmissive substrate having at least a portion of one surface incident the light pathway that is coated with an anti-reflective material. Referring to FIG. 2, a cross-sectional view of a light-transmissive substrate 200 having surfaces 202 and 204 coated with an anti-reflective material for providing a light pathway 206 to an optical MEMS device 208 is illustrated in accordance with a second embodiment of the present invention. MEMS device 208 is attached to a surface 202 of substrate 200. Substrate 200 and its surfaces 202 and 204 provide for light pathway 206 to MEMS device 208. Substrate 200 is manufactured of silicon, a light-transmissive material, for allowing light to pass along light pathway 206. Alternatively, substrate 200 can be made of any suitable light-transmissive material compatible with MEMS device 208.

Substrate surfaces 202 and 204 are coated with an anti-reflective material for minimizing the blocking, reflecting or filtering of light on transmission though surfaces 202 and 204. Anti-reflective material is applied as a film or multi-layer films on the substrate surface. In this embodiment, the anti-reflective material applied to surfaces 202 and 204 is a blanket, unpatterned coating. Alternatively, the anti-reflective material can be applied to only a portion of substrate surfaces 202 and 204 that is incident light pathway 206. Furthermore, in the alternate, one side of surface 202 or 204 incident light pathway 206 can be without an antireflective material.

In this embodiment, the thickness of the single layer film coating of antireflective material on surfaces 202 and 204 is given by the following equation (wherein N represents the film index of refraction, D represents the film thickness, and λ represents the wavelength of incident light):

N=λ/(4*D)

The ideal index of refraction of the film is given by the following equation (wherein Nf represents the index of refraction for the antireflective film, and n1 and n2 represent the index of refraction of the bonding media):

Nf=\sqrt{n1*n2}

For a single layer film on silicon, low losses results through a 190-nanometer, an anti-reflective material film of Si₃N₄ can be employed at a center wavelength of approximately 1547 nanometers or other suitable center wavelength as known to those of skill in the art. Furthermore, magnesium flouride (MgF₂) and cryolite can be used as an anti-reflective material for glass. As known to those of skill in the art, other mathematical relationships can be used and other mathematical relationships are appropriate for multi-layer antireflective coatings. The need for a light-transmissive substrate having an anti-reflective coating versus a substrate having an aperture depends on many parameters, including the wavelength band of the light, the wavelength dependent optical properties of the materials (i.e., transmissibility), and the ability to integrate an antireflective coating into the optical MEMS fabrication process.

Pathway 206 extends through substrate 200 and the anti-reflective material coating on surfaces 202 and 204 toward MEMS device 208 for interaction. Light can be transmitted in a direction indicated by direction arrow x 210 along pathway 206 through substrate 200 or along pathway 206 in a direction opposite direction arrow x 210.

The substrates described above for providing a light pathway can be used in combination with a light-transmissive protective cover for providing a light pathway to a MEMS device positioned between the substrate and cover. Referring to FIG. 3, a cross-sectional view of a substrate 300 having a MEMS device 302 and cover 304 attached thereto for providing a pathway 306 for the transmission of light to MEMS device 302 is illustrated in accordance with another embodiment of the present invention. MEMS device 302 is attached to a surface 308 of substrate 300. Cover 304 is attached to substrate surface 308 in a position for protecting MEMS device 302 from other fabrication processes or the operational environment of MEMS device 302.

Substrate 300 is manufactured of silicon in this embodiment. Alternatively, substrate 300 can be manufactured of any suitable material known to those of skill in the art compatible with optical MEMS device 302, such as glass, gallium arsenide (GaAs), quartz, sapphire, or silicon-on-insulator. In this embodiment, substrate 300 and cover 304 are made of the same material for ease of manufacture, but, alternatively, they can be made of different materials.

Light can be transmitted along pathway 306 in a direction indicated by direction arrow x 310 or in a direction opposite direction arrow x 310. Pathway 306 extends through substrate 300 to MEMS device 302 for interaction with MEMS device 302. Additionally, pathway 306 extends through cover 304. Light pathways are provided through substrate 300 and cover 304 by apertures 312 and 314, respectively. Apertures 312 and 314 are manufactured in substrate 300 and cover 304 as described above. MEMS device 302 can redirect, filter, or block light transmitted along pathway 306.

Cover 304 is attached to substrate 300 by an attachment process after attachment of MEMS device 302. In this embodiment, cover 304 is bonded by an anodic bonding process. Alternatively, the cover can be bonded by a process of fusion bonding, Au eutectic bonding, glass frit bonding, epoxy bonding, and other suitable types of bonding or encapsulation methods known to those of skill in the art.

Referring to FIG. 4, a cross-sectional view of a substrate 400 having a MEMS device 402 and cover 404 attached thereto for providing a light pathway 406 to MEMS device 402 is illustrated in accordance with an embodiment of the present invention. MEMS device 402 is attached to a surface 408 of substrate 400. Cover 404 is attached to substrate surface 408 in a position for protecting optical MEMS device 402.

In this embodiment, substrate 400 and cover 404 are manufactured of silicon. Substrate 400 can be made of any suitable material known to those of skill in the art for attaching MEMS device 402 and cover 404 thereto. Additionally, cover 404 can be made of any other suitable material known to those of skill in the art.

Light can be transmitted along pathway 406 in a direction indicated by direction arrow x 410 or in a direction opposite direction arrow x 410. Pathway 406 extends through substrate 400 to MEMS device 402 for potential interaction with MEMS device 402. Furthermore, pathway 406 extends through cover 404. MEMS device 402 can redirect, filter, or block light transmitted along pathway 406. An aperture 412 is provided through substrate 400 for allowing the unimpeded transmission of light along pathway 406. Aperture 412 can be manufactured as described above.

Cover 404 is manufactured of a light-transmissible material as described above for allowing light to pass along pathway 406. Surfaces 416 and 418 of cover 404 are coated with an anti-reflective material for minimizing the blocking, reflecting or filtering of light on transmission through surfaces 414 and 416. Cover 404 is attached to substrate 400 by an attachment process after MEMS device 402 as described above. In this embodiment of the present invention, the process for bonding cover 404 must be compatible with the anti-reflective coating required for the respective materials and optical wavelengths.

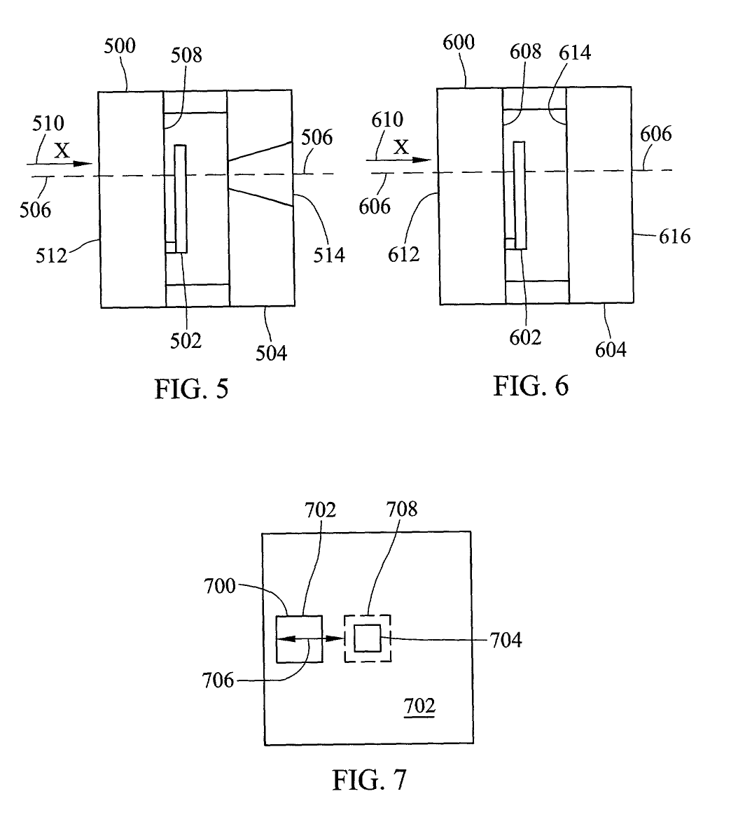

Referring to FIG. 5, a cross-sectional view of a substrate 500 having an MEMS device 502 and cover 504 attached thereto for providing a pathway 506 to MEMS device 502 is illustrated in accordance with an embodiment of the present invention. MEMS device 502 is attached to a surface 508 of substrate 500. Cover 504 is attached to substrate surface 500 in a position for protecting optical MEMS device 502.

In this embodiment, substrate 500 and cover 504 are manufactured of silicon. Silicon is a light-transmissible material as described above, for allowing light to pass along light pathway 506. Substrate 500 can be manufactured of any light-transmissible material known to those of skill in the art that is suitable for attaching optical MEMS device 502 and cover 504 thereto. Alternatively, substrate 500 and cover 504 can be made of any other suitable materials known to those of skill in the art.

Light can be transmitted along pathway 506 in a direction indicated by direction arrow x 510 or in a direction opposite direction arrow x 510. Pathway 506 extends through substrate 500 to MEMS device 502 for potential interaction with MEMS device 502. Furthermore, pathway 506 extends through cover 504. MEMS device 502 can redirect, filter, or block light transmitted along pathway 506.

Surfaces 508 and 512 of substrate 500 are coated with an anti-reflective material for minimizing the blocking, reflecting or filtering of light on transmission though surfaces 508 and 512. Furthermore, substrate 500 and the anti-reflective material coated on surfaces 508 and 512 are suitable for attaching MEMS device 502 and cover 504 thereto. An aperture 514 is provided through cover 504 for allowing the unimpeded transmission of light along pathway 506. Aperture 514 can be formed in cover 504 as described above. Cover 504 is attached to substrate 500 by an attachment process after MEMS device 502 as described above.

Referring to FIG. 6, a cross-sectional view of a substrate 600 having a MEMS device 602 and cover 604 attached thereto for providing a light pathway 606 to MEMS device 602 is illustrated in accordance with an embodiment of the present invention. MEMS device 602 is attached to a surface 608 of substrate 600. Cover 604 is attached to substrate surface 608 in a position for protecting optical MEMS device 602.

Substrate 600 and cover 604 are manufactured of a light-transmissible material as described above for allowing light to pass along light pathway 606. Substrate 600 is manufactured of any material suitable for attaching optical MEMS device 602 and cover 604 thereto. In this embodiment, substrate 600 and cover 604 are manufactured of silicon. Alternatively, substrate 600 and cover 604 can be made of different materials.

Light can transmit in a direction indicated by direction arrow x 610 or in a direction opposite direction arrow x 610. Pathway 606 extends through substrate 600 to MEMS device 602 for potential interaction with MEMS device 602. Furthermore, pathway 606 extends through cover 604. MEMS device 602 can redirect, filter, or block light transmitted along pathway 606.

Surfaces 608 and 612 of substrate 600 and surfaces 614 and 616 of substrate 600 are coated with an anti-reflective material as described above for minimizing the blocking, reflecting or filtering of light on transmission though surfaces 608, 612, 614, and 616.

Cover 604 is attached to substrate 600 by an attachment process after MEMS device 602 as described above. In this embodiment of the present invention, the process for bonding cover 604 must be compatible with the antireflective coating required for the respective materials and optical wavelengths.

A MEMS device according to either of FIGS. 1-6 can interact with the information on intercepted light in several ways, such as directing, absorbing, reflecting, or transmitting the light in a discrete or analog fashion in different embodiments of the present invention. Generally, there are a number of ways in which a MEMS device can interact with intercepted light. In one embodiment, a component, such as a shutter for filtering, blocking or reflecting light, is moved into and out of a position intercepting the light pathway.

Movement of a component parallel and perpendicular to an array of MEMS devices can be achieved with electrostatic, thermal and magnetic energy mechanisms. Electrostatic actuation can be implemented with comb drives, variable gap parallel-plates, variable area parallel-plates, or scratch drive designs. Thermal actuation can be implemented with bent beam mechanism designs or pairs of geometric thermally mismatched structures. Magnetic actuation of individual shutters can be implemented with a coil on the component or a fixed coil on the substrate, both with an external magnetic field.

Optical MEMS devices for use with the present invention must be configured to interact with light transmitted along a pathway through the substrate on which the optical MEMS device is manufactured. Some of the optical MEMS devices which interact with light in this way function to move a component into a position intercepting the light pathway. Other optical MEMS devices according to the present invention can interact with the transmitted light in other ways.

FIGS. 7-20 provide exemplary embodiments of MEMS devices interacting with light transmitted along a light pathway through the substrate. Referring to FIG. 7, a diagram is provided to illustrate exemplary motion of a component 700 along substrate surface 702 in relation to a light pathway 704 extending in a direction perpendicular to surface 702 in order to interact with light transmitted along pathway 704. Component 700 moves in a direction (indicated by direction arrow 706) between a position outside of light pathway 704 (as shown) and a position 708 (indicated by broken lines) intercepting light pathway 704. Component 700 moves in a linear direction (indicated by arrow 706) parallel to substrate surface 702.

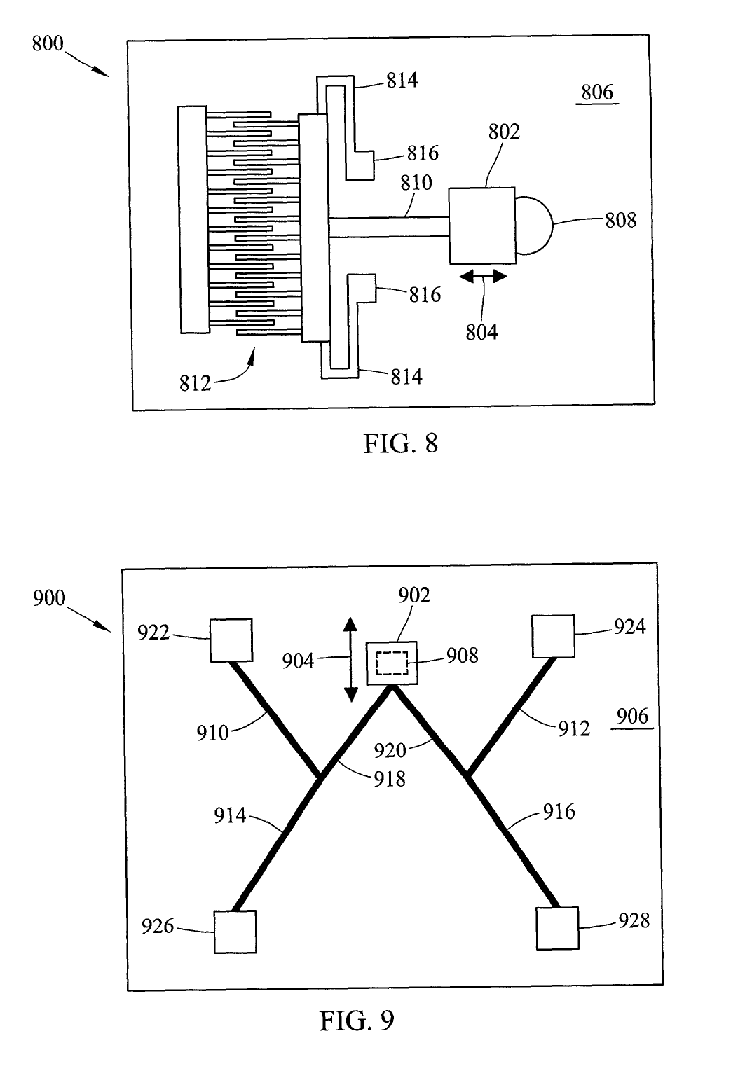

As known to those of skill in the art, a number of MEMS devices are capable of moving a component in a linear direction parallel to the substrate surface. Referring to FIG. 8, a schematic diagram of an electrostatic comb-drive type MEMS device generally designated 800 is illustrated for moving a component 802 linearly (indicated by direction arrows 804) parallel to the plane of substrate surface 806. As shown, component 802 is in a position partially intercepting light transmitted through light pathway 808. Component 802 is attached to a movable portion 810 of comb-drive 800. A voltage is applied across fixed combs, shown generally at 812 to produce a force on movable portion 810, thereby moving component 802. Movable portion 810 is attached to substrate via a spring 814 and an anchor 816. Spring 814 allows movable portion to have relative moment with respect to substrate surface 806 while remaining attached.

Referring to FIG. 9, a schematic diagram of a thermal, bent-beam actuator type MEMS generally designated 900 is illustrated for moving component 902 in a linear direction (indicated by direction arrows 904) parallel to substrate surface 906. As shown, component 902 is in a position intercepting light transmitted through light pathway 908 (indicated by broken lines). Component 902 is moved when current is applied through a set of side arms (910, 912, 914, and 916) thereby causing Joule heating of these elements. Joule heating causes elongation to arms (910, 912, 914, and 916). By the configuration of arms (910, 912, 914, and 916), elongation is translated into movement of the component 902 in a straight line. When no current is applied, component 902 is in a position outside the light pathway 908. When a sufficient current is applied, component 902 is in a position partially intercepting light transmitted through light pathway 908. Beams 918 and 920 attach component 902 to arms (910, 912, 914, and 916). Anchors (922, 924, 926, and 928) attach MEMS device 900 to substrate surface 906.

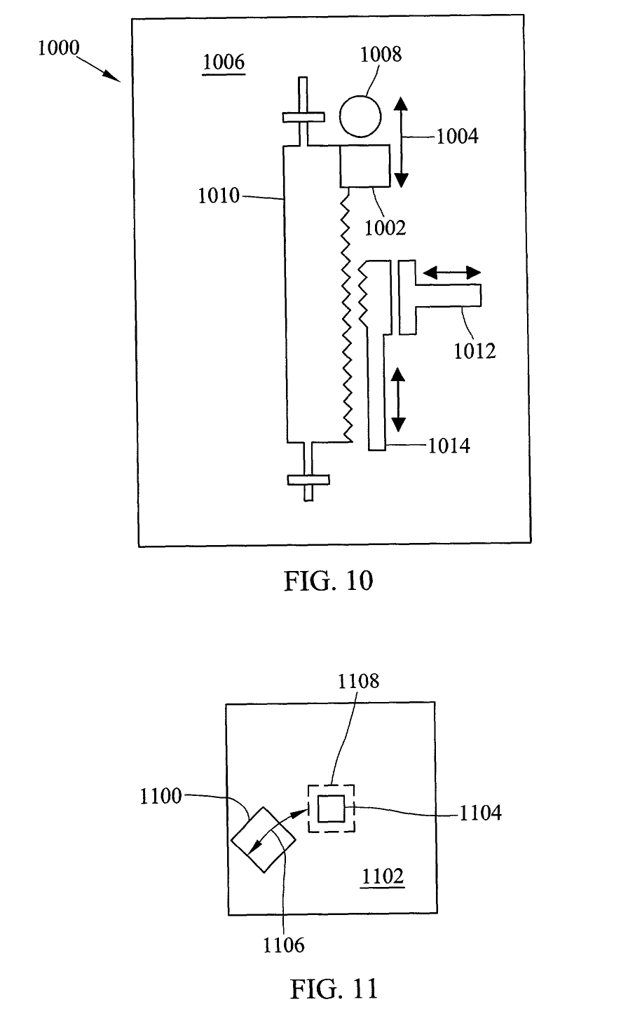

Referring to FIG. 10, a schematic diagram of a linear actuator type MEMS device generally designated 1000 for moving a component 1002 in a linear direction (indicated by direction arrows 1004) parallel to substrate surface 1006 is illustrated. As shown, component 1002 is in a position outside a light pathway 1008 transmitted through substrate surface 1006. Linear actuator 1000 includes an electrostatic linear motor, which can alternatively be thermal or any other known energy mechanism. Shuttle plate 1010 is attached to component 1002 for moving it in a position intercepting light transmitted through light pathway 1008. Shutter plate 1010 is moved by the sequential action of a push pawl 1012-drive pawl 1014 stepper mechanism. A single shuttle plate 1010 displacement step occurs when; push pawl 1012 is actuated such that it makes contact with drive pawl 1014 and moves drive pawl 1014 into contact with the shuttle plate 1010. When this occurs, drive pawl 1014 is actuated in the directions indicated by direction arrow 1004 and push pawl 1012 and drive pawl 1014 actuators are de-energized such that they return to their initial states. The stepper mechanism can be driven by different transduction mechanisms such as electrostatic or thermal actuators.

Referring to FIG. 11, illustrates a schematic diagram of the exemplary motion of a component 1100 along a substrate surface 1102 in relation to a light pathway 1104 extending in a direction perpendicular to surface 1102 in order to interact with light transmitted along pathway 1104. Component 1100 moves in a curvilinear direction (indicated by arrow 1106) between a position outside of light pathway 1104 (as shown) and a position 1108 (indicated by broken lines) intercepting light pathway 1104. This type of motion can be due to a MEMS device using electrostatic, thermal, and magnetic actuation methods. The desired motion can be attained with lateral zippers, angular comb drives, angular scratch drives, or variable gap parallel-plate electrostatic designs. Thermal designs can use geometric thermal mismatched structures or offset antagonistic actuators utilizing thermal expansion. Motion using magnetism can be accomplished using a magnetic component and an external magnetic field.

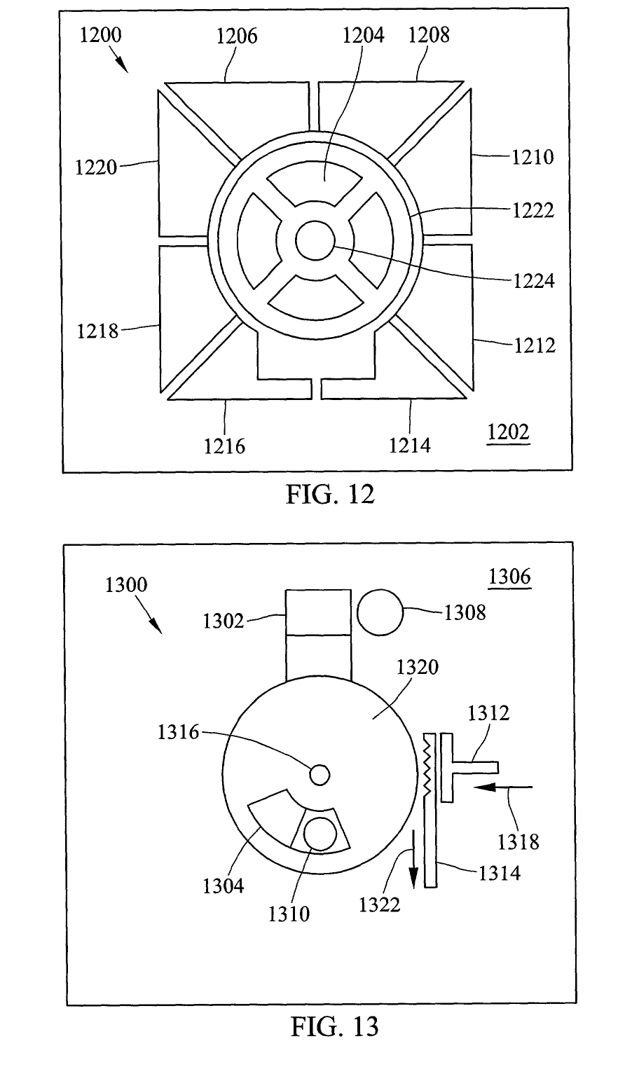

Referring to FIG. 12, a schematic diagram of a MEMS device generally designated 1200 having an electrostatic micromotor is illustrated for moving a component in a curvilinear direction parallel to substrate surface 1202. MEMS device 1200, when activated, can move a component into a position intercepting light transmitted through a light pathway 1204. MEMS device 1200 includes a set of stators 1206, 1208, 1210, 1212, 1214, 1216, 1218, and 1220, a rotor 1222, and bearing 1224. When actuated, rotor 1222 moves about bearing 1224 in a curved motion for moving the component. MEMS device 1200 can be used as a continuous analog motion or a discrete motion. In continuous analog motion mode of operation, a variable amount of the light is intercepted. In the discrete motion mode of operation, the light is either fully intercepted (an “ON” position) or allowed to pass (an “OFF” position). The rotational motion is produced by a translation-rotation stepper motor, which can be thermal or electrostatic. Stators 1206,1208,1210,1212,1214,1216,1218, and 1220 are used to set up electrostatic fields in a manner that produces a torque on the rotor. The voltage potential on stators 1206, 1208, 1210, 1212, 1214, 1216, 1218, and 1220 are switched between a ground potential voltage and a high potential voltage in a rotary fashion around rotor 1222 such that there are asymmetric electrostatic field lines generating a torque on rotor 1222, which is set to zero potential voltage.

Referring to FIG. 13, a schematic diagram of a MEMS device generally designated 1300 having an electrostatic micromotor is illustrated for moving a component 1302 and 1304 in a curvilinear direction parallel to substrate surface 1306. MEMS device 1300, when activated, can move components 1302 and 1304 into a position intercepting light transmitted through light pathways 1308 and 1310, respectively. MEMS device 1300 further includes a push pawl 1312 and drive pawl 1314, which cause components 1302 and 1304 to rotate about an axis 1316 in a curved motion. The rotational motion is produced by a translation-rotation stepper motor, which can be thermal or electrostatic. The push pawl 1312 is actuated in the direction of a direction arrow 1318 such that push pawl 1312 makes contact with the drive pawl 1314 and moves the drive pawl 1314 into contact with the rotor 1320, at which time the drive pawl 1314 is actuated in the directions indicated by the direction arrow 1322, and finally the push pawl 1312 and drive pawl 1314 actuators are de-energized such that they return to their initial states. This operation has moved components 1302 and 1304 into position such that the light is intercepted. The operation can be reversed by operating the push pawl 1312 in the same direction shown by direction arrow 1318 but by reversing the direction of motion of the drive pawl 1314 indicated by direction arrow 1322.

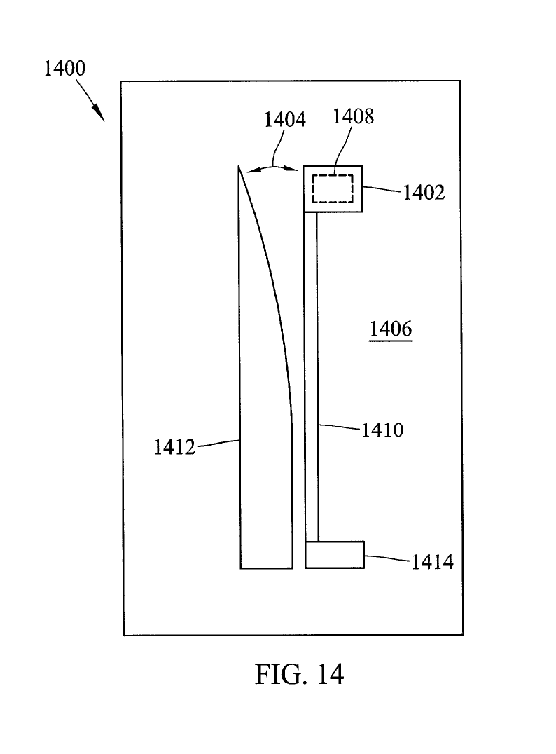

Referring to FIG. 14, a schematic diagram of an electrostatic, curved electrode actuator type MEMS device generally designated 1400 is illustrated for moving a component 1402 in a curvilinear direction (indicated by direction arrow 1404) parallel to substrate surface 1406. As shown, component 1402 is positioned for intercepting light transmitted through light pathway 1408 (shown with broken lines). MEMS device 1400, when activated, can move component 1402 in a position away from light pathway 1408. MEMS device 1400 includes a deformable, electrode beam 1410, a curved electrode 1412, and an anchor 1414. A voltage is applied across electrode beam 1410 and curved electrode 1412 in order to produce an opposite charge on each. An electrostatic force is generated which pulls the electrostatic beam 1410, held stationary at one end by anchor 1414, towards curved electrode 1412. A rotational motion is produced by the electrode beam 1410 bending towards electrode 1412. In a final position, component 1402 is in a position intercepting the light from light pathway 1408.

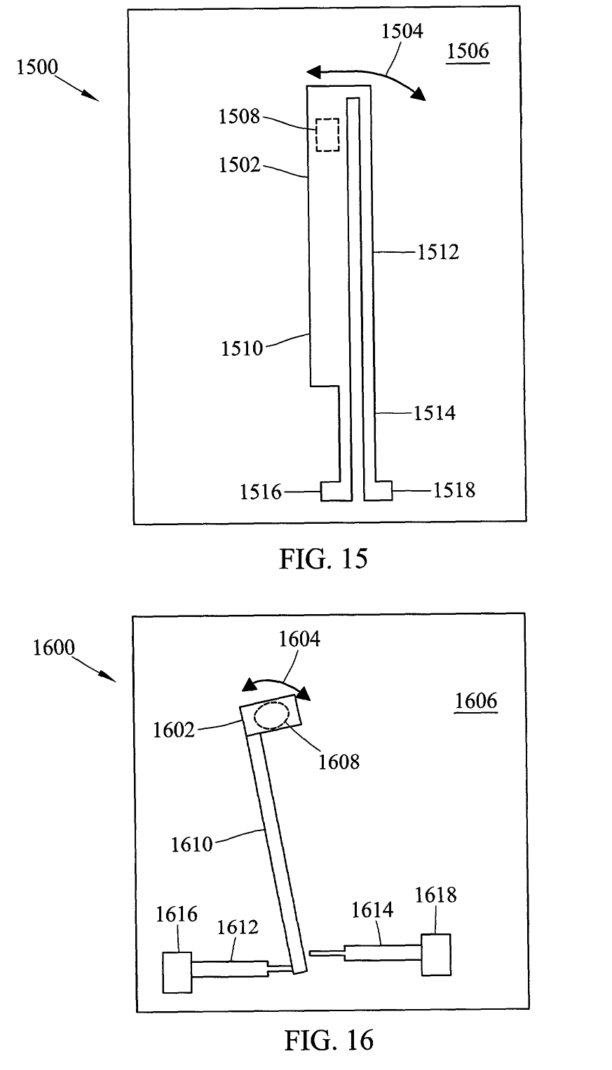

Referring to FIG. 15, a schematic diagram of a thermal actuator type MEMS device generally designated 1500 is illustrated for moving component 1502 in a curved line (indicated by direction arrows 1504) in the plane of substrate surface 1506. As shown, component 1502 is in a position intercepting light transmitted through light pathway 1508 (indicated by broken lines). Actuator 1500 includes a wide arm 1510, a narrow arm 1512, and a flexure 1514. In operation, current passes through wide arm 1510 and narrow arm 1512. Narrow arm 1512 heats up more than wide arm 1510 because of additional Joule heating. Joule heating causes narrow arm 1512 to elongate more than wide arm 1510. A curved motion due to bending at flexure 1514 due to the attachment of wide arm 1510 and narrow arm 1512 to anchors 1516 and 1518, respectively. The resultant motion of component 1502, attached to the end of wide arm 1510, moves it into a position outside the light pathway 1508.

Referring to FIG. 16, a schematic diagram of an MEMS device actuator generally designated 1600 is illustrated for moving a component 1602 in a curved line (indicated by direction arrows 1604) in the plane of substrate surface 1606. As shown, component 1602 is in a position intercepting a pathway 1608 (shown in broken lines) for transmitting light through substrate surface 1606. Actuator 1600 includes a lever arm 1610 attached to component 1602, shape memory alloy beams 1612 and 1614 positioned offset from one another, and anchors 1616 and 1618, respectively. On the application of current to beams 1612 and 1614, they each exert a force at a different point on the length of lever arm 1610 near one end. This exertion causes a torque on lever arm 1610 to force the distal end of lever arm 1610 in a curved motion. At a final position, component 1602 attached to the distal end is moved into a position outside of light pathway 1608. In alternate embodiments, actuator 1600 is implemented as a thermal actuator for extending the length of beams 1612 and 1614.

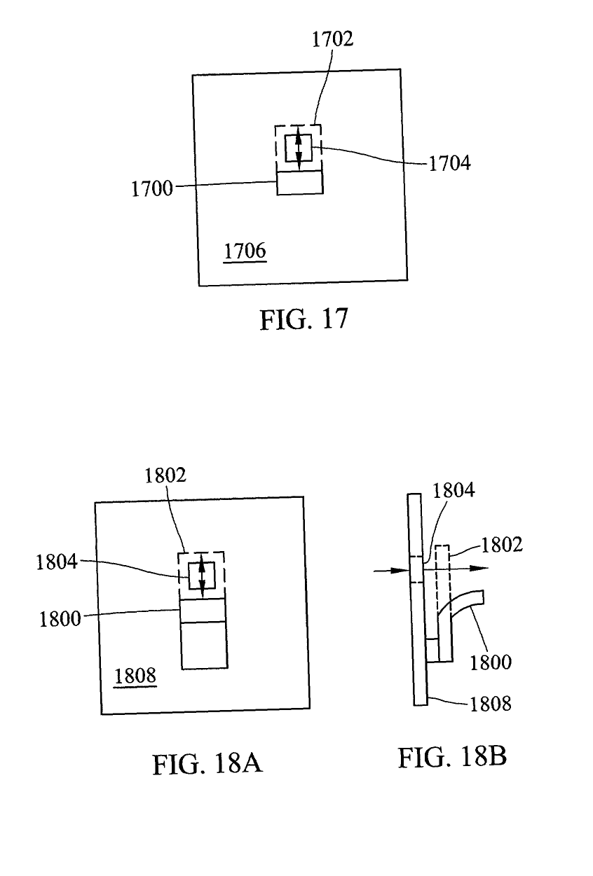

Referring to FIG. 17, a diagram is provided to illustrate exemplary rotating motion of a component 1700 from a position 1702 (indicated by broken lines) intercepting a light pathway 1704 to a position outside light pathway 1704 (as shown). At a position 1702, component 1700 is parallel to the plane of substrate surface 1706. Component is in a plane substantially perpendicular to the plane of substrate surface 1706 (as shown). This type of motion can be due to a MEMS device using electrostatic, thermal, and magnetic actuation methods. These types of schemes use linkages, pivots, and pop-up levers in order to achieve out-of-plane motion. Furthermore, out-of-plane motion can be achieved using an electromagnetic coil on the shutter in conjunction with an external magnetic field.

Referring to FIGS. 18A and 18B, diagrams are provided to illustrate the curling motion of a component 1800 from a position 1802 (indicated by broken lines) intercepting a light pathway 1804 (indicated by an arrow) to a position (as shown) outside pathway 1804. FIG. 18A illustrates a top view of component 1800 and substrate 1808. FIG. 18B illustrates a side view of component 1800 and substrate 1808. In a position 1802 intercepting light pathway 1804, component is in a plane substantially parallel to the plane of substrate 1808. As shown, component 1800 is curled to a position outside light pathway 1804.

A curling motion can be implemented with electrostatic, thermal, magnetic, and piezoelectric actuator designs. Parallel-plate electrostatic actuation can be used to curl a cantilever beam between positions. The initial curl in the cantilever beam can be accomplished by taking advantage of residual film stresses in a bimetallic cantilever, or by plastically deforming the cantilever through thermal heating. In a similar manner, an initially curled bimetallic cantilever beam could be driven down to the substrate by Joule heating the bi-materials. A cantilever beam can also be made to lay flat or curl out-of-plane by inducing Joule heating in a beam made with a shape memory alloy material. Magnetic actuation can be used to pull an initially curled cantilever beam towards or away from a light pathway through the interaction of an electromagnetic coil or magnetic material on the beam and an external magnetic field. Piezoelectric actuation can be used to control the curvature of a cantilever beam by using the expansion of a piezoelectric material in a bimetallic system. In plane, free shutter rotation can be achieved with electrostatics through the use of a stepper motor driven by a ratchet mechanism, an angular comb drive, or a rotary micromotor design with sidewall or substrate electrodes.

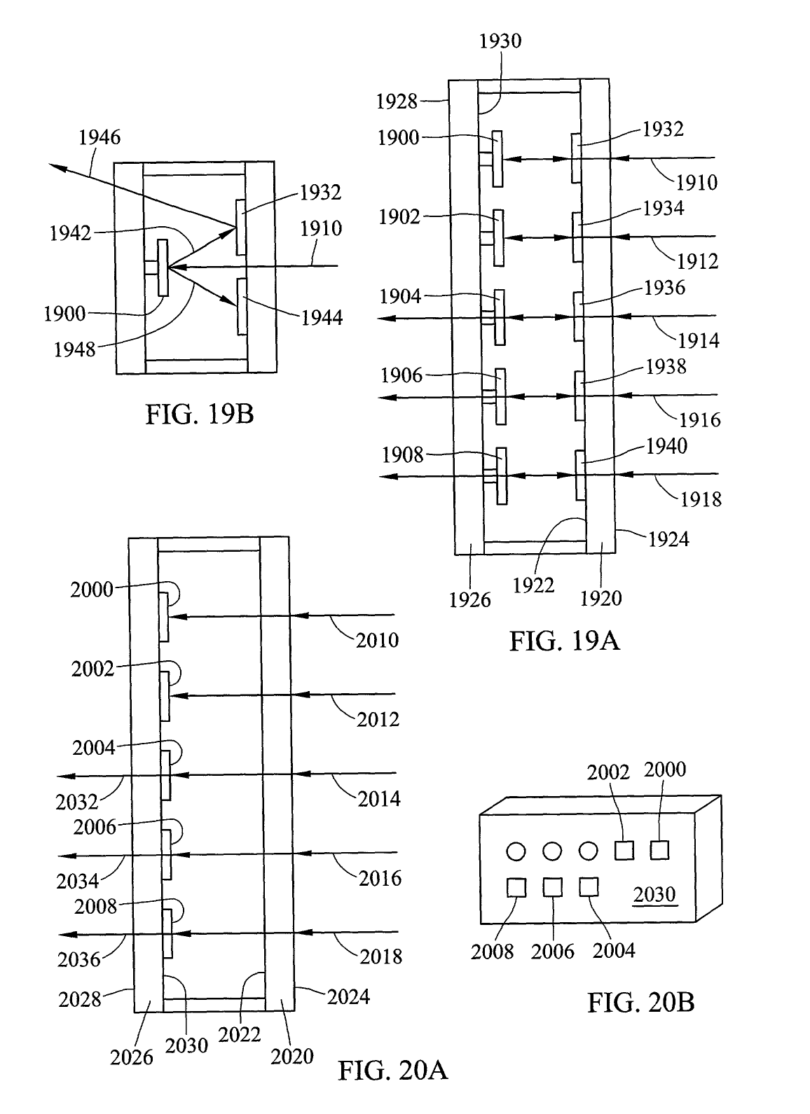

Referring to FIGS. 19A and 19B, diagrams of a top view and an end view, respectively, are provided of a set of MEMS devices, each having a torsional mirror each associated with an absorbing and reflecting plate for interacting with transmitted light. Referring to FIG. 19A, torsional mirrors 1900, 1902, 1904, 1906, and 1908 intercept light transmitted along light pathways 1910, 1912, 1914, 1916, and 1918, respectively. Cover 1920 has surfaces 1922 and 1924 coated with antireflective material to provide pathways for light transmitted on pathways 1910, 1912, 1914, 1916, and 1918. Furthermore, substrate 1926 has surfaces 1928 and 1930 coated with antireflective material for allowing light reflected off reflecting plates 1932, 1934, 1936, 1938, and 1940 to pass through substrate 1926. Alternative to coating cover 1920 and substrate 1926 with an antireflective material, apertures may be manufactured into substrates as described above to provide light pathways.

Referring to FIG. 19B, a diagram is provided of the end view of the set of MEMS devices each associated with an absorbing and reflecting plate for interacting with transmitted light. Light is transmitted along pathway 1910 to torsional mirror 1900. Torsional mirror 1900 can be actuated to reflect light along a pathway 1942 to reflecting plate 1932 or to an absorbing plate 1944. If torsional mirror 1900 is positioned to reflect light to reflecting plate 1932, light is reflected along pathway 1946 through substrate 1926. Otherwise, if torsional mirror 1900 is positioned to reflect light to absorbing plate 1944, light is absorbed after following a light pathway 1948 to absorbing plate 1944.

Referring to FIGS. 20A and 20B, diagrams of an end view and a cross-sectional top view, respectively, are provided of a set of MEMS devices having a shutter for interacting with transmitted light. Referring to FIG. 20A, shutters 2000, 2002, 2004, 2006, and 2008 can be positioned for blocking, or filtering, light transmitted along light pathways 2010, 2012, 2014, 2016, and 2018, respectively. Cover 2020 has surfaces 2022 and 2024 coated with antireflective material to provide pathways for light transmitted on pathways 2010, 2012, 2014, 2016, and 2018. Furthermore, substrate 2026 has surfaces 2028 and 2030 coated with antireflective material for allowing light to pass that is not intercepted by shutters 2000, 2002, 2004, 2006, and 2008. As shown, shutters 2004, 2006, and 2008 are not positioned in front of light passing along pathways 2032, 2034, and 2036, respectively. Shutters 2000 and 2002 block, or filter, light transmitted along light pathways 2010 and 2012, respectively. Alternative to coating cover 2020 and substrate 2026 with an antireflective material, apertures may be manufactured into substrates as described above to provide light pathways.

Referring to FIG. 20B, substrate surface 2030 is illustrated with shutters 2000, 2002, 2004, 2006, and 2008. Shutters 2000 and 2002 are positioned for intercepting light. Shutters 2004, 2006, and 2008 are shown in a position outside of light pathways 2032, 2034, and 2036, respectively, for allowing light to pass through substrate 2026.

Thus, a light-transmissive substrate having a MEMS devices attached thereto according to the present invention is provided. Although the present invention has been described with respect to MEMS devices for interacting with light, the principles of the present invention also can be applied to other devices require interaction with light transmitted along a pathway through a substrate. Furthermore, it will be understood that various details of the invention may be changed without departing from the scope of the invention. The foregoing description is for the purpose of illustration only, and not for the purpose of limitation-the invention being defined by the claims.

What is claimed is:

1. An optical device, comprising:
(a) a substrate having an aperture for providing a first pathway for light transmission; and
(b) a device attached to a surface of the substrate for interacting with light transmitted along the first pathway.

2. The optical device of claim 1 wherein the first pathway is substantially perpendicular to the surface of the substrate.

3. The optical device of claim 1 wherein the aperture is formed in the substrate by anisotropic etching.

4. The optical device of claim 3 wherein the aperture is etched in a KOH solution.

5. The optical device of claim 3 wherein the aperture is etched in a EDP solution.

6. The optical device of claim 3 wherein the aperture is etched in a TMAH solution.

7. The optical device of claim 3 wherein the aperture is etched by a deep reactive ion etch (DRIE).

8. The optical device of claim 1 wherein the device is an optical micro-electro-mechanical device.

9. The optical device of claim 8 wherein the optical micro-electro-mechanical device includes a component for interacting with light transmitted along the first pathway.

10. The optical device of claim 9 wherein the component filters light transmitted along the first pathway.

11. The optical device of claim 9 wherein the component reflects light transmitted along the first pathway.

12. The optical device of claim 9 wherein the component can be moved into a position intercepting the first pathway for interacting with light transmitted along the first pathway.

13. The optical device of claim 1 further comprising a cover attached to the substrate surface and having an aperture for providing a second pathway for light transmission to the device.

14. The optical device of claim 13 wherein the cover is attached to the substrate surface adjacent to the device for protecting the device.

15. The optical device of claim 1 further comprising a cover comprised of a light-transmissive material and having surfaces coated with an anti-reflective material for providing a second pathway for light transmission and attached to the substrate surface.

16. An optical device, comprising:
(a) a substrate comprised of a light-transmissive material having a first surface portion coated with an anti-reflective material for providing a first pathway for light transmission through the substrate; and
(b) a device attached to a surface of the substrate for interacting with light transmitted along the first pathway.

17. The optical device of claim 16 wherein the substrate comprises silicon.

18. The optical device of claim 16 wherein the substrate comprises glass.

19. The optical device of claim 16 wherein the substrate includes a second surface portion coated with the anti-reflective material on an opposite side of the substrate.

20. The optical device of claim 16 wherein the anti-reflective material comprises magnesium fluoride.

21. The optical device of claim 16 wherein the anti-reflective material comprises cryolite.

22. The optical device of claim 16 wherein the device is an optical micro-electro-mechanical device.

23. The optical device of claim 22 wherein the optical micro-electro-mechanical device includes a component for interacting with light transmitted along the first pathway.

24. The optical device of claim 23 wherein the component for filtering light transmitted along the first pathway.

25. The optical device of claim 23 wherein the component for reflecting light transmitted along the first pathway.

26. The optical device of claim 23 wherein the component can be moved into a position intercepting the first pathway for interacting with light transmitted along the first pathway.

27. The optical device of claim 16 further comprising a cover attached to the substrate surface and having an aperture for providing a second pathway for light transmission to the device.

28. The optical device of claim 27 wherein the cover is attached to the substrate surface adjacent to the device for protecting the device.

29. The optical device of claim 16 further comprising a cover comprised of a light-transmissive material and having surfaces coated with an anti-reflective material for providing a second pathway for light transmission and attached to the substrate surface.
